(19) United States
(12) Patent Application Publication
(10) Pub. No.: US 2026/0089213 A1
(43) Pub. Date: Mar. 26, 2026

(54) COMPUTING SYSTEM FOR REMOTE MEMORY ALLOCATION BASED ON OPTICAL SWITCH AND OPERATION METHOD OF THE SAME

(71) Applicant: ELECTRONICS AND TELECOMMUNICATIONS RESEARCH INSTITUTE, Daejeon (KR)

(72) Inventor: Jongtae SONG, Daejeon (KR)

(73) Assignee: ELECTRONICS AND TELECOMMUNICATIONS RESEARCH INSTITUTE, Daejeon (KR)

(21) Appl. No.: 19/327,738

(22) Filed: Sep. 12, 2025

(30) Foreign Application Priority Data
Sep. 23, 2024 (KR) 10-2024-0128298

(51) Int. Cl. H04L 67/1097; G06F 15/173; H04L 67/1008

(52) U.S. Cl. CPC H04L 67/1097; G06F 15/17331; H04L 67/1008

(57) ABSTRACT

According to an embodiment of the present disclosure, an operation method of a computing system for a remote memory allocation includes, monitoring, by an each of a plurality of servers including a local memory and a CPU (Central Processing Unit), a load of the local memory, requesting, by a first server of the plurality of servers, an allocation of a remote memory to an optical disaggregation manager when a load of a local memory of the first server is large, checking whether the remote memory is allocated based on a request of the first server, and allocating or hand overing the remote memory to the first server based on a result of the checking.

### CROSS-REFERENCE TO RELATED APPLICATIONS

This application claims priority under 35 U.S.C. § 119 to Korean Patent Application No. 10-2024-0128298 filed on Sep. 23, 2024, in the Korean Intellectual Property Office, the disclosures of which are incorporated by reference herein in their entireties.

### BACKGROUND

The present disclosure is related to a computing system, and more particularly, to a computing system for a remote memory allocation based on an optical switch and an operation method of the same.

A cloud computing architecture is evolving from a homogeneous computing architecture where a performance of a Central Processing Unit (CPU) is important to a heterogeneous computing architecture where a fast data exchange between computing resources is important. As the cloud computing architecture is evolving into the heterogeneous computing architecture, an importance of a disaggregation technique to distribute the computing resources and connect the computing resources has grown.

A goal of the disaggregation technique is a fast connection between the computing resources. For fast connection, an electrical switch connecting the computing resources are used. However, as an amount of data transmitted by the computing resources increases, connecting the computing resources through the electrical switch may be limited. Therefore, it is necessary to quickly connect the computing resources using an optical switch.

### SUMMARY

Embodiments of the present disclosure provide a computing system for a remote memory allocation based on an optical switch and an operation method of the same.

According to an embodiment of the present disclosure, an operation method of a computing system for a remote memory allocation comprises, monitoring, by an each of a plurality of servers including a local memory and a CPU (Central Processing Unit), a load of the local memory; requesting, by a first server of the plurality of servers, an allocation of a remote memory to an optical disaggregation manager when a load of a local memory of the first server is large; checking whether the remote memory is allocated based on a request of the first server; and allocating or hand overing the remote memory to the first server based on a result of the checking.

In an embodiment, the allocating or hand overing the remote memory to the first server includes, allocating the remote memory to the first server, when the remote memory is not allocated to any of the plurality of servers; and hand overing the remote memory to the first server, when the remote memory is allocated to one of the plurality of servers.

In an embodiment, the allocating the remote memory to the first server includes, setting an optical switch such that a CPU of the first server and the remote memory are connected.

In an embodiment, the hand overing the remote memory to the first server includes, requesting a handover of the remote memory to a second server of the plurality of servers, the remote memory being allocated to the second server; monitoring a load of a local memory of the second server and a load of the remote memory based on the requesting of the handover; and hand overing the remote memory from the second server to the first server based on a result of the monitoring.

In an embodiment, the monitoring the load of the local memory of the second server and the load of the remote memory includes, notifying that the handover is available to the optical disaggregation manager, when the load of the local memory of the second server is small.

In an embodiment, the monitoring the load of the local memory of the second server and the load of the remote memory includes, migrating data of the remote memory to the local memory of the second server, when the load of the local memory of the second server is small.

In an embodiment, the hand overing the remote memory from the second server to the first server includes, disconnecting a CPU of the second server and the remote memory, and setting an optical switch such that a CPU of the first server and the remote memory are connected.

According to an embodiment of the present disclosure, a computing system comprises, an optical disaggregation manager; an each of a plurality of servers including a local memory and a CPU (Central Processing Unit), and configured to monitor a load of the local memory; and an optical switch configured to connect a remote memory with one of the plurality of servers. A first server of the plurality of servers is configured to request an allocation of the remote memory to the optical disaggregation manager, when a load of a local memory of the first server is large, and the optical disaggregation manager is configured to check whether the remote memory is allocated based on a request of the first server, and allocate or handover the remote memory to the first server, based on a result of the checking.

In an embodiment, the optical disaggregation manager is configured to, allocate the remote memory to the first server, when the remote memory is not allocated to any of the plurality of servers, and request a handover of the remote memory to the second server, when the remote memory is allocated to a second server of the plurality of servers.

In an embodiment, the optical disaggregation manager is configured to, allocate the remote memory to the first server by setting the optical switch such that a CPU of the first server and the remote memory are connected, when allocating the remote memory to the first server.

In an embodiment, the second server is configured to, monitor a load of a local memory of the second server and a load of the remote memory based on the requested handover, and notify that the handover is available to the optical disaggregation manager, when the load of the local memory of the second server is small.

In an embodiment, the second server is configured to, migrate data of the remote memory to the local memory of the second server, when the load of the local memory of the second server is small.

In an embodiment, the optical disaggregation manager is configured to, disconnect a CPU of the second server and the remote memory based on the notification that the handover is available of the second server, and set the optical switch such that a CPU of the first server and the remote memory are connected.

In an embodiment, the optical switch includes, a plurality of host optical adapters, configured to convert signals respectively transmitted by the plurality of servers into optical signals and transmit the optical signals to the remote memory; and a device optical adapter configured to convert a signal transmitted by the remote memory into an optical signal and transmit the optical signal to the plurality of servers.

### BRIEF DESCRIPTION OF THE FIGURES

The above and other objects and features of the present disclosure will become apparent by describing in detail embodiments thereof with reference to the accompanying drawings.

FIG. 1 is a diagram illustrating a computing system, according to an embodiment of the present disclosure.

FIG. 2 is a diagram for describing how the memories of a plurality of servers of FIG. 1 are used.

FIG. 3 is a flowchart illustrating an operation for allocating a remote memory of FIG. 1.

FIGS. 4A and 4B are flowcharts illustrating operations of hand overing a remote memory of FIG. 1.

FIGS. 5A and 5B are diagrams for describing operations of migrating data from a remote memory to a local memory.

FIG. 6 is a diagram illustrating an optical switch of FIG. 1.

### DETAILED DESCRIPTION

Below, embodiments of the present disclosure will be described in detail and clearly to such an extent that an ordinary one in the art easily carries out the present disclosure.

As used herein, including in the claims, “or” as used in a list of items (e.g., a list of items prefaced by a phased such as “at least one of” or “one or more of” or “one or both of” indicates as inclusive list such that, for example, a list of at least one of A, B, or C means A or B or C or AB or AC or BC or ABC (i.e., A and B and C).

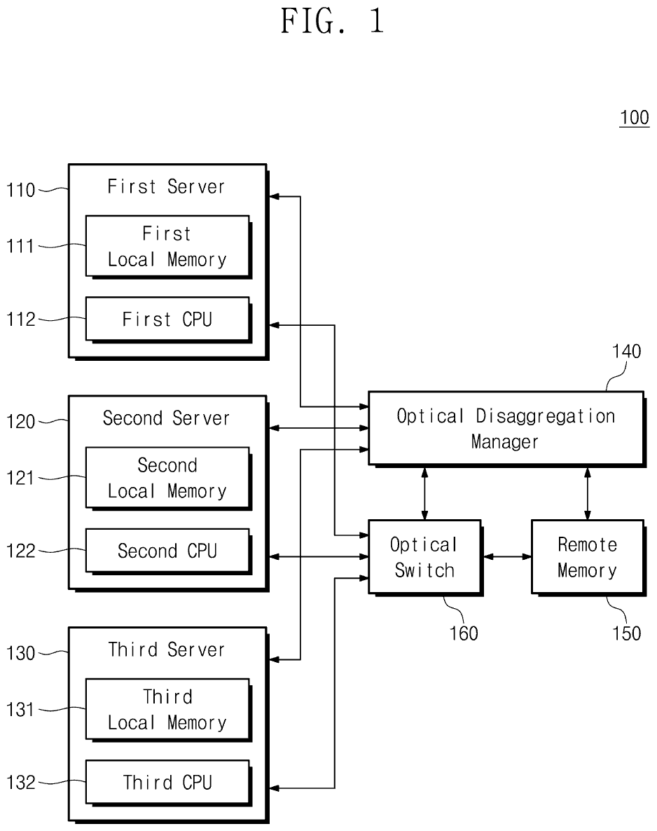

FIG. 1 is a diagram illustrating a computing system, according to an embodiment of the present disclosure. Referring to FIG. 1, a computing system 100 may include a plurality of servers 110, 120, and 130, an optical disaggregation manager 140, a remote memory 150, and an optical switch 160.

An each of the plurality of servers 110, 120, and 130 may include a local memory and a CPU (Central Processing Unit). For example, the first server 110 may include a first local memory 111 and a first CPU 112. The second server 120 may include a second local memory 121 and a second CPU 122, and the third server 130 may include a third local memory 131 and a third CPU 132.

In an embodiment, the plurality of servers 110, 120, and 130 may process data through CPUs 112, 122, and 132, respectively. For example, the first server 110 may process data through the first CPU 112. The first to third servers 110, 120, and 130 may store data processed through the CPUs 112, 122, and 132 in the first to third local memories 111, 121, and 131, respectively.

In an embodiment, the plurality of servers 110, 120, and 130 may monitor a load of the local memories 111, 121, and 131, respectively. For example, when the load of the local memories 111, 121, and 131 is large, the plurality of servers 110, 120, and 130 may respectively request an allocation of the remote memory 150 to the optical disaggregation manager 140. For example, the more data that is processed through the CPUs 112, 122, and 132, the larger the load on the local memories 111, 121, and 131. For example, when a load of the first local memory 111 is large, the first server 110 may request an allocation of the remote memory 150 to the optical disaggregation manager 140.

The optical disaggregation manager 140 may check whether the remote memory 150 is allocated. For example, to allocate or handover the remote memory 150 to one of the plurality of servers 110, 120, and 130, the optical disaggregation manager 140 may check whether the remote memory 150 is allocated.

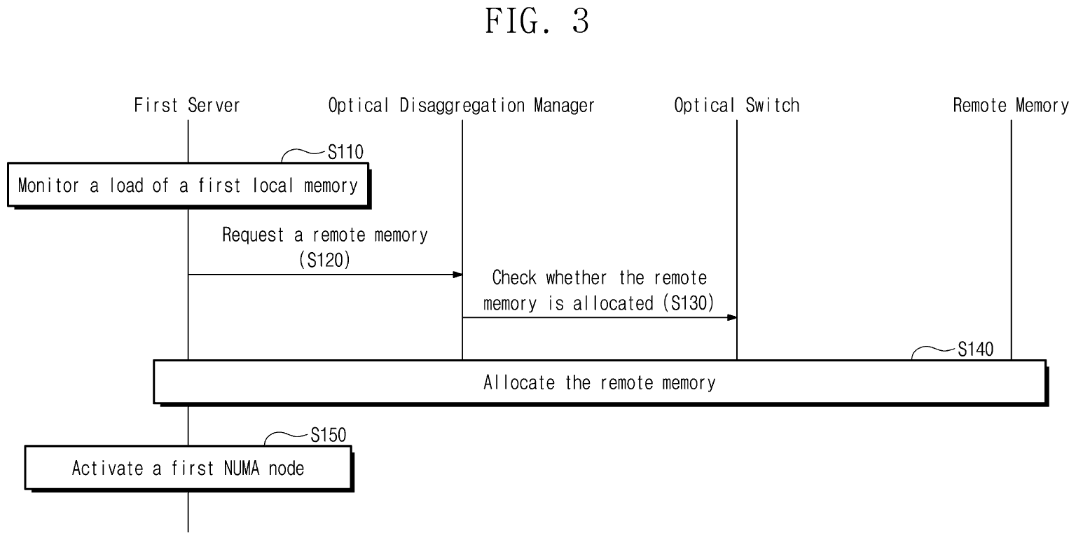

In an embodiment, the optical disaggregation manager 140 may allocate the remote memory 150 to one of the plurality of servers 110, 120, and 130. For example, when the remote memory 150 is not allocated to any server, the optical disaggregation manager 140 may allocate the remote memory 150 to one of the plurality of servers 110, 120, and 130. An operation of allocating the remote memory 150 will be described below with reference to FIG. 3.

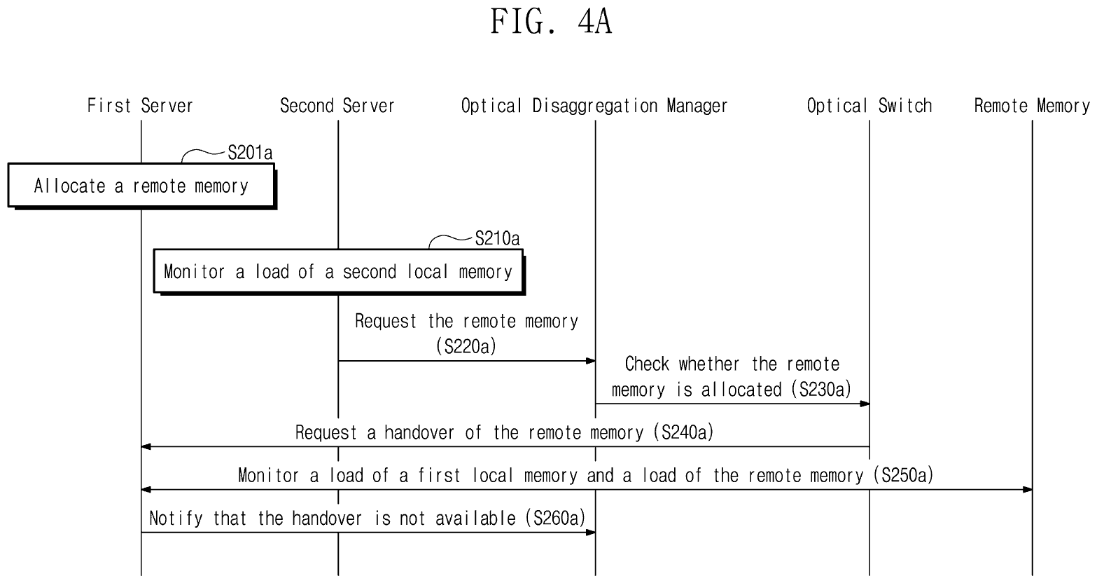

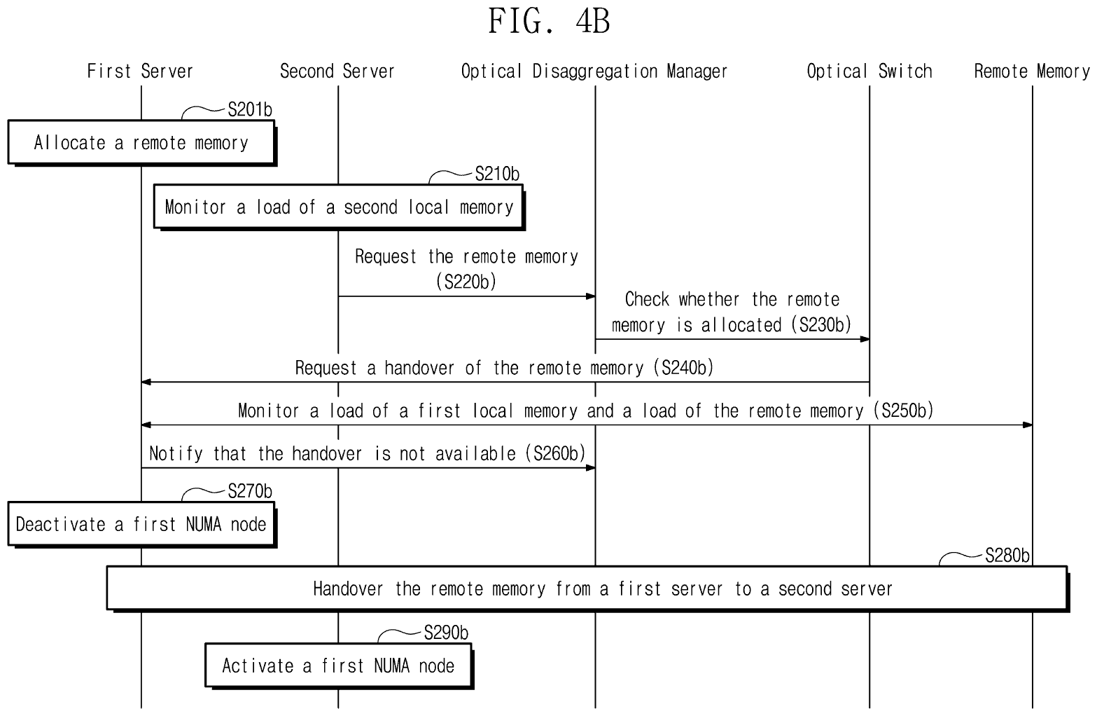

In an embodiment, the optical disaggregation manager 140 may handover the remote memory 150. For example, when the remote memory 150 is allocated to one server, the optical disaggregation manager 140 may handover the remote memory 150 from one server to another server. An operation of hand overing the remote memory will be described below with reference to FIGS. 4A and 4B.

In an embodiment, the optical disaggregation manager 140 may set the optical switch 160. For example, the optical disaggregation manager 140 may set the optical switch 160 such that one of the plurality of servers 110, 120, and 130 is connected with the remote memory 150.

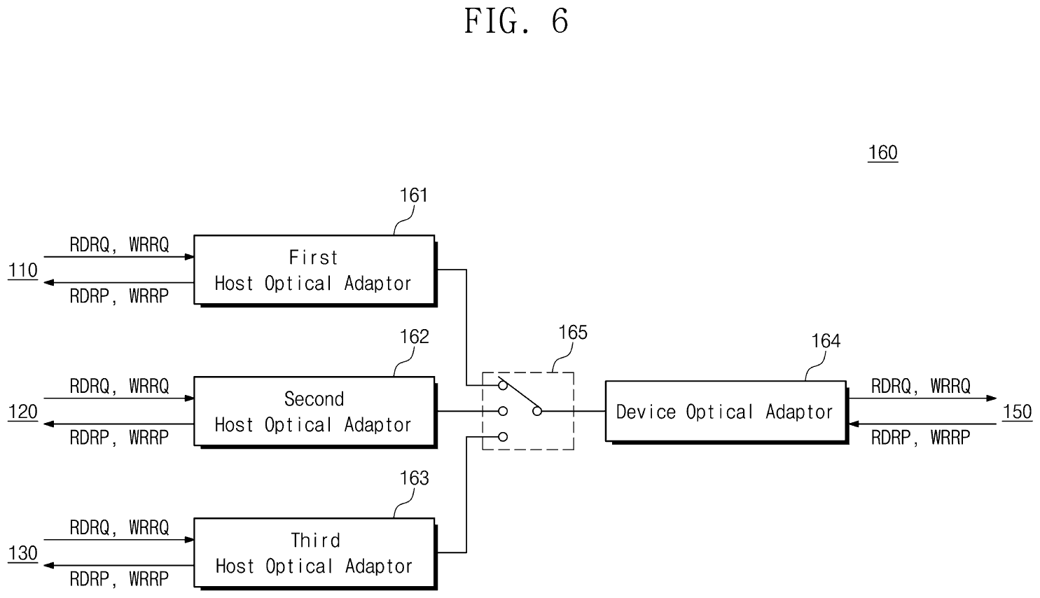

The optical switch 160 may connect one of the plurality of servers 110, 120, and 130 with the remote memory 150. The optical switch 160 may convert a signal received from the one of the plurality of servers 110, 120, and 130 into an optical signal. The optical switch 160 may convert a signal received from the remote memory 150 into an optical signal. The optical switch will be described below with reference to FIG. 6.

With the above-described configurations, the computing system for a remote memory allocation based on an optical switch and an operation method of the same according to the embodiments of the present disclosure may respectively monitor the load of the local memory of the plurality of servers, and allocate the remote memory through the optical switch to the server with a large load of the local memory. The computing system and the operation method of the same, in a state allocating the remote memory to one server, may handover the remote memory to another server through the optical switch when the load of the local memory of the other server is large. The computing system and the operation method of the same may effectively use limited memory resources to improve utilization efficiency of the memory resources, and resource allocation and data migration may be made faster using the optical switch.

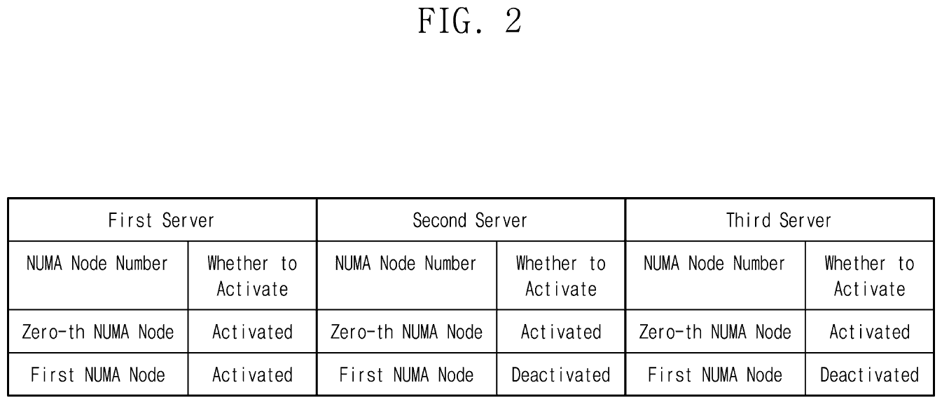

FIG. 2 is a diagram for describing how the memories of a plurality of servers of FIG. 1 are used.

Referring to FIGS. 1 and 2, a Non-Uniform Memory Access (NUMA) node number of the plurality of servers 110, 120, and 130 and whether the NUMA node is activated are illustrated. A NUMA node may refer to a local memory or a remote memory. For example, the zero-th NUMA node may refer to the local memories 111, 121, and 131 of the servers 110, 120, and 130. The first NUMA node may refer to the remote memory 150.

In an embodiment, when a NUMA node is activated, the plurality of servers may use memory corresponding to the activated NUMA node. For example, when the zero-th NUMA node of the first server 110 is activated, the first server 110 may use the first local memory 111. When the first NUMA node of the first server 110 is activated, the first server 110 may use the remote memory 150. When the zero-th NUMA node of the second server 120 is activated, the second server 120 may use the second local memory 121. For example, when the first NUMA node of the second server 120 is deactivated, the second server 120 may not use the remote memory 150.

In an embodiment, as the remote memory 150 is connected with one of the plurality of servers 110, 120, and 130 through the optical switch 160, the first NUMA node may be activated for only one of the plurality servers 110, 120, and 130.

FIG. 3 is a flowchart illustrating an operation for allocating a remote memory of FIG. 1.

Referring to FIGS. 1 and 3, in an operation S110, the first server 110 may monitor the load of the first local memory 111. For example, the larger the data processed through the first CPU 112, the larger the load of the first local memory 111 may be.

In an operation S120, the first server 110 may request an allocation for the remote memory 150 to the optical disaggregation manager 140. For example, when the load of the first local memory 111 is large, the first server 110 may request the allocation for the remote memory 150 to the optical disaggregation manager 140.

In an operation S130, the optical disaggregation manager 140 may check whether the remote memory 150 is allocated from the optical switch 160. For example, based on the allocation request for the remote memory 150 of the first server 110, the optical disaggregation manager 140 may check whether the remote memory 150 is allocated from the optical switch 160.

In an operation S140, the optical disaggregation manager 140 may allocate the remote memory 150 to the first server 110. For example, when the optical switch 160 does not connect the remote memory 150 with any server, the optical disaggregation manager 140 may allocate the remote memory 150 to the first server 110. For example, the optical disaggregation manager 140 may set the optical switch 160 such that the first CPU 112 of the first server 110 is connected with the remote memory 150.

In an operation S150, the first server 110 may activate a first NUMA node of the first server 110. For example, based on the optical switch 160 being set such that the first CPU 112 of the first server 110 is connected with the remote memory 150, the first server 110 may activate the first NUMA node. For example, when the first NUMA node is activated, the first server 110 may use the remote memory 150. For example, the first server 110 may store data not only in the first local memory 111, but also in the remote memory 150.

FIGS. 4A and 4B are flowcharts illustrating operations of hand overing a remote memory of FIG. 1. For describing the operations of hand overing the remote memory, it is assumed that the optical disaggregation manager 140 allocates the remote memory 150 to the first server 110 (S201a and S201b).

At first, referring to FIGS. 1 and 4A, in an operation S210a, the second server 120 may monitor the load of the second local memory 121. For example, the more data processed through the second CPU 122, the larger the load of the second local memory 121 may be.

In an operation S220a, the second server 120 may request an allocation for the remote memory 150 to the optical disaggregation manager 140. For example, when the load of the second local memory 121 is large, the second server 120 may request the allocation for the remote memory 150 to the optical disaggregation manager 140.

In an operation S230a, the optical disaggregation manager 140 may check whether the remote memory 150 is allocated. For example, based on the allocation request for the remote memory 150 of the second server 120, the optical disaggregation manager 140 may check whether the remote memory 150 is allocated.

In an operation S240a, the optical disaggregation manager 140 may request a handover of the remote memory 150 to the first server 110. For example, when the remote memory 150 is allocated to the first server 110, the optical disaggregation manager 140 may request the handover of the remote memory 150 to the first server 110.

In an operation S250a, the first server 110 may monitor the load of the first local memory 111 and the load of the remote memory 150. For example, to determine whether to handover the remote memory 150, the first server 110 may monitor the load of the first local memory 111 and the load of the remote memory 150.

In an operation S260a, the first server 110 may notify that the handover is not available to the optical disaggregation manager 140. For example, when the load of the first local memory 111 and the load of the remote memory 150 are large, the first server 110 may notify that the handover of the remote memory 150 is not available to the optical disaggregation manager 140. For example, the first server 110 may not deactivate the first NUMA node. For example, the first server 110 may continue to use the remote memory 150. For example, the first server 110 may store data not only in the first local memory 111, but also in the remote memory 150.

Next, referring to FIGS. 1 and 4B, in an operation S210b, the second server 120 may monitor the load of the second local memory 121, and in an operation S220b, the second sever 120 may request the remote memory 150 to the optical disaggregation manager 140. In an operation S230b, the optical disaggregation manager 140 may check whether the remote memory 150 is allocated, and in an operation S240b, the optical disaggregation manager 140 may request a handover of the remote memory 150 to the first server 110. In an operation S250b, the first server 110 may monitor the load of the first local memory 111 and the load of the remote memory 150.

In an operation S260b, the first server 110 may notify that the handover is available to the optical disaggregation manager 140. For example, when the load of the first local memory 111 and the load of the remote memory 150 are small, the first server 110 may notify that the handover of the remote memory 150 is available to the optical disaggregation manager 140.

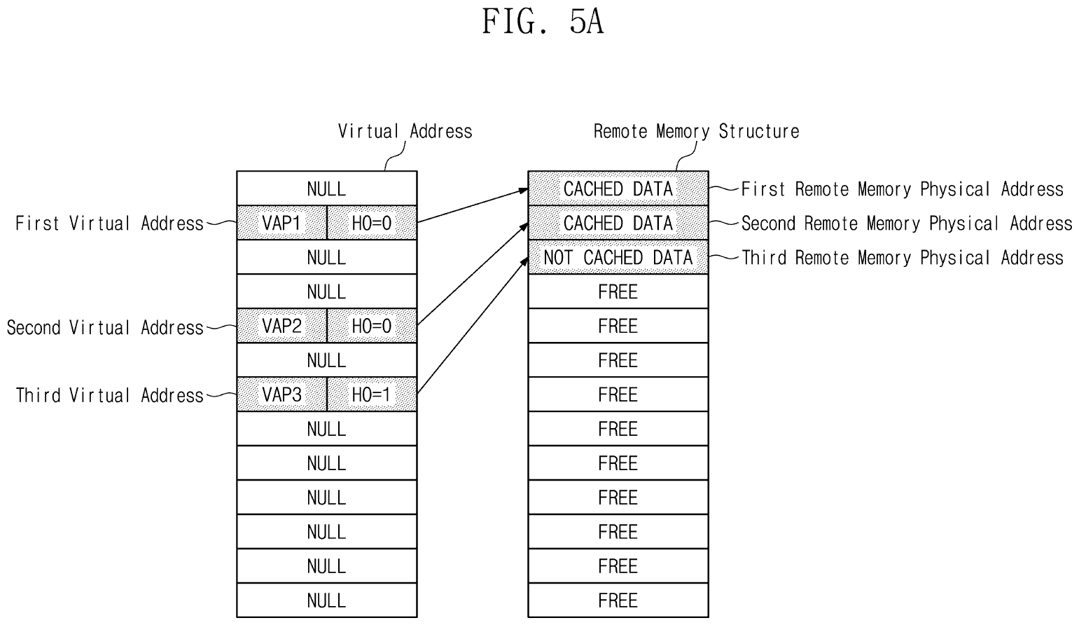

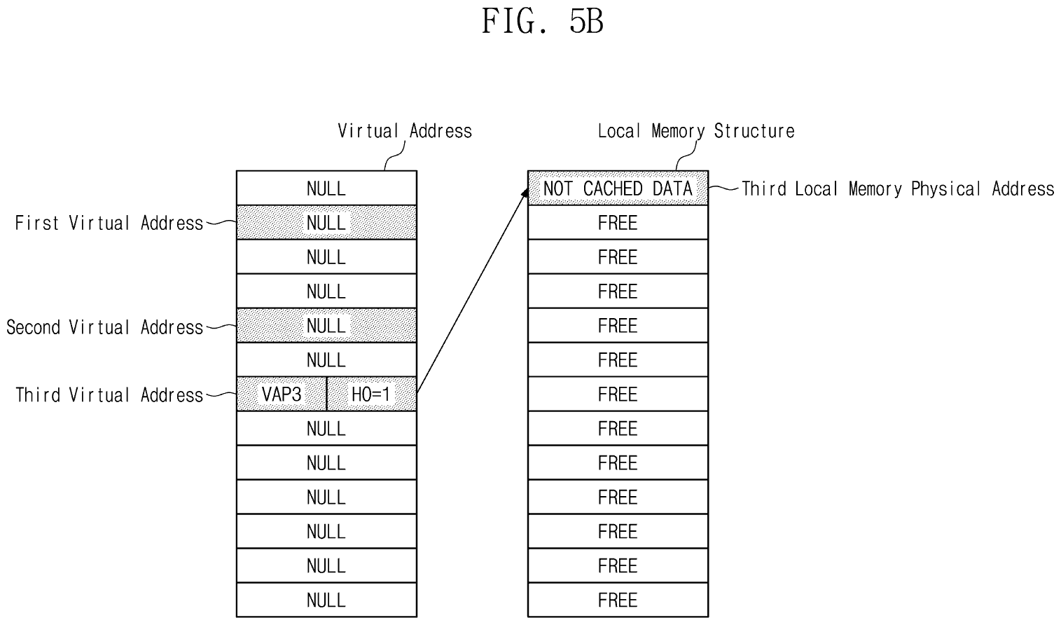

In an operation S270b, the first server 110 may deactivate the first NUMA node of the first server 110. For example, based on the notifying that the handover is available to the optical disaggregation manager 140, the first server 110 may deactivate the first NUMA node. For example, the first server 110 may deactivate the first NUMA node to migrate data from the remote memory 150 to the first local memory 111. For example, when the first NUMA node is deactivated, the first server 110 may not use the remote memory 150, and may only use the first local memory 111. For example, the first server 110 may store data only in the first local memory 111. Operations of migrating data from the remote memory 150 to the first local memory 111 will be described below with reference to FIGS. 5A and 5B.

In an operation S280b, the optical disaggregation manager 140 may handover the remote memory 150 from the first server 110 to the second server 120. For example, the optical disaggregation manager 140 may disconnect the optical switch 160. For example, the optical switch 160 may disconnect the first server 110 and the remote memory 150. The optical disaggregation manager 140 may then set the optical switch 160 such that the second CPU 122 of the second server 120 is connected with the remote memory 150.

In an operation S290b, the second server 120 may activate the first NUMA node of the second server 120. For example, based on the optical switch 160 being set such that the second CPU 122 is connected with the remote memory 150, the second server 120 may activate the first NUMA node of the second server 120. For example, when the first NUMA node is activated, the second server 120 may use the remote memory 150. For example, the second server 120 may store data not only in the second local memory 121, but also in the remote memory 150. Therefore, when the remote memory 150 is handovered from the first server 110 to the second server 120, the first server 110 may not use the remote memory 150, and the second server 120 may use the remote memory 150.

FIGS. 5A and 5B are diagrams for describing operations of migrating data from a remote memory to a local memory.

Referring first to FIGS. 1 and 5A, a virtual address and a remote memory structure are illustrated.

The remote memory structure may include physical addresses for the remote memory 150. For example, when the remote memory 150 is allocated to the servers 110, 120, and 130, the data processed through the CPUs 112, 122, and 132 of the servers 110, 120, and 130 may be stored in a remote memory physical address. The remote memory physical address where no data is stored may have a FREE value. Referring to FIG. 5A, the first to third remote memory physical addresses may be in a state that the data is stored.

The virtual address may be an address that stores a virtual address pointer (VAP). For example, a virtual address pointer (VAP) may be connected with a remote memory physical address that stores data. For example, a first virtual address pointer VAP1 may be connected with a first remote memory physical address. A second virtual address pointer VAP2 may be connected with a second remote memory physical address, and a third virtual address pointer VAP3 may be connected with a third remote memory physical address.

In an embodiment, the virtual address may have a NULL value. For example, the virtual address for which the virtual address pointer (VAP) is not stored may have the NULL value. For example, the virtual address that is not connected with the remote memory physical address that stored the data may have the NULL value.

In an embodiment, the CPUs 112, 122, and 132 of the servers 110, 120, and 130 may have used data among the data stored in the remote memory 150. The used data may be cached in the CPUs 112, 122, and 132. For example, the data stored at the first remote memory physical address and the second remote memory physical address may be cached data.

In an embodiment, the CPUs 112, 122, and 132 of the servers 110, 120, and 130 may have unused data among the data stored in the remote memory 150. The unused data may not be cached in the CPUs 112, 122, and 132. For example, the data stored at the third remote memory physical address may be uncached data.

In an embodiment, the virtual address connected with the remote memory physical address storing the cached data may have a HO=0 value. For example, the first virtual address and the second virtual address connected with the first remote memory physical address and the second remote memory physical address, respectively, storing the cached data may have the HO=0 value.

In an embodiment, a virtual address connected with a remote memory physical address storing the uncached data may have a HO=1 value. For example, the third virtual address connected with the third remote memory physical address storing the uncached data may have the HO=1 value.

In an embodiment, the CPUs 112, 122, and 132 may use data that is not cached. For example, the CPUs 112, 122, and 132 may use uncached data stored at the third remote memory physical address.

In an embodiment, when data not being cached by the CPUs 112, 122, and 132 is used, the virtual address connected with the remote memory physical address storing the uncached data may be changed from the HO=1 value to the HO=0 value. For example, when uncached data stored at the third remote memory physical address by the CPUs 112, 122, and 132 is used, the third virtual address connected with the third remote memory physical address may be changed from the HO=1 value to the HO=0 value.

Next, referring to FIGS. 1 and 5B, a virtual address and a local memory structure are illustrated. The local memory structure may include physical addresses for the local memories 111, 121, and 131.

In an embodiment, the local memory physical address illustrated in FIG. 5B may be the physical address of the local memory to which data is migrated from the remote memory. For example, data may be migrated from the remote memory physical address illustrated in FIG. 5A to the local memory physical address illustrated FIG. 5B.

In an embodiment, the local memory physical address illustrated in FIG. 5B may be a local memory physical address of a server deactivating the first NUMA node. For example, the server deactivating the first NUMA node may be the first server 110 of FIG. 4B, but this is merely illustrative.

In an embodiment, the server deactivating the first NUMA node may deactivate a virtual address pointer (VAP) of the virtual address with HO=0 value. As the virtual address pointer (VAP) is deactivated, the virtual address may have a NULL value. For example, the server deactivating the first NUMA node may deactivate the first virtual address pointer VAP1 and the second virtual address pointer VAP2. Thus, the first virtual address and the second virtual address may have the NULL value.

In an embodiment, the server deactivating the first NUMA node may change the virtual address pointer (VAP) of the virtual address with HO=1 value. For example, the server deactivating the first NUMA node may change the virtual address pointer (VAP) of the virtual address having the HO=1 value from the remote memory physical address to the local memory physical address. The changed virtual address pointer (VAP) may be connected with the local memory physical address. For example, the server deactivating the first NUMA node may change the third virtual address pointer VAP3 from the third remote memory physical address to the third local memory physical address. The changed third virtual address pointer VAP3 may be connected with the third local memory physical address.

In an embodiment, a server deactivating a first NUMA node may migrate and store data associated with a virtual address having a HO=1 value from a remote memory physical address to a local memory physical address. For example, the server deactivating the first NUMA node may migrate data associated with a third virtual address having the HO=1 value from a third remote memory physical address to a third local memory physical address for storage.

In an embodiment, the server deactivating the first NUMA node may not migrate the data associated with the virtual address having the HO=0 value from the remote memory physical address to the local memory physical address. For example, the server deactivating the first NUMA node may migrate only data associated with the virtual address having the HO=1 value, but not the HO=0 value, from the remote memory physical address to the local memory physical address. For example, the server deactivating the first NUMA node may not migrate data stored at the first remote memory physical address and the second remote memory physical address, respectively, to the local memory physical address. Thus, the server deactivating the first NUMA node may reduce the amount of data migrated.

In an embodiment, the CPUs 112, 122, and 132 may use uncached data being migrated from the remote memory physical address to the local memory physical address. For example, the CPUs 112, 122, and 132 may use the uncached data being migrated from the third remote memory physical address to the third local memory physical address.

In an embodiment, when data not being cached by the CPUs 112, 122, and 132 is used, the virtual address connected with the local memory physical address storing the uncached data may be changed from the HO=1 value to the HO=0 value. For example, when the uncached data stored at the third local memory physical address by the CPUs 112, 122, and 132 are used, the third virtual address connected with the third local memory physical address may be changed from the HO=1 value to the HO=0 value.

FIG. 6 is a diagram illustrating an optical switch of FIG. 1.

Referring to FIGS. 1 and 6, the optical switch 160 may include a plurality of host optical adapters 161, 162, and 163, a device optical adapter 164, and a SP3T (Single Pole Triple Throw) 165.

An each of the plurality of servers 110, 120, and 130 may transmit a signal to the remote memory 150. For example, the plurality of servers 110, 120, and 130 may transmit a read request signal RDRQ or a write request signal WRRQ, respectively, to the remote memory 150. The read request signal RDRQ or the write request signal WRRQ may be a signal requesting to read data from the remote memory 150 or requesting to write data to the remote memory 150.

The remote memory 150 may transmit a signal to the plurality of servers 110, 120, and 130. For example, the remote memory 150 may transmit a read response signal RDRP in response to the read request signal RDRQ or a write response signal WRRP in response to the write request signal WRRQ to the plurality of servers 110, 120, and 130.

The plurality of host optical adapters 161, 162, and 163 may receive signals from the plurality of servers 110, 120, and 130, respectively, and may convert the received signals into optical signals, respectively. For example, the first host optical adapter 161 may receive the read request signal RDRQ or the write request signal WRRQ from the first server 110, and may convert the received read request signal RDRQ or write request signal WRRQ into an optical signal.

The device optical adapter 164 may receive a signal from the remote memory 150 and may convert the received signal into an optical signal. For example, the device optical adapter 164 may receive the read response signal RDRP or the write response signal WRRP from the remote memory 150, and may convert the received read response signal RDRP or write response signal WRRP into the optical signal.

In an embodiment, the plurality of host optical adapters 161, 162, and 163 may transmit the converted optical signal to the device optical adapter 164 and may receive the converted optical signal from the device optical adaptor 164. For example, the plurality of host optical adapters 161, 162, and 163 may transmit the converted read request signal or the converted write request signal to the device optical adapter 164 and may receive the converted read response signal or the converted write response signal from the device optical adaptor 164.

In an embodiment, the device optical adapter 164 may transmit the converted optical signal to the plurality of host optical adapters 161, 162, and 163 and may receive the converted optical signal from the plurality of host optical adapters 161, 162, and 163. For example, the device optical adapter 164 may transmit the converted read response signal or the converted write response signal to the plurality of host optical adapters 161, 162, and 163 and may receive the converted read request signal or the converted write request signal from the plurality of host optical adapters 161,162, 163.

The SP3T 165 may connect one of the plurality of host optical adapters 161, 162, and 163 with the device optical adapter 164. For example, the optical disaggregation manager 140 may allocate the remote memory 150 to one of the plurality of servers 110, 120, and 130. For example, the optical disaggregation manager 140 may set the optical switch 160 such that one of the plurality of servers 110, 120, and 130 is connected with the remote memory 150. For example, the optical switch 160 may set the SP3T 165 such that one of the plurality of servers 110, 120, and 130 is connected with the remote memory 150.

As described above, the computing system for the remote memory allocation based on the optical switch and the operation method of the same according to the embodiments of the present disclosure may respectively monitor the load of the local memory of the plurality of servers, and allocate the remote memory to the server having the large load of the local memory through the optical switch. In a state that the remote memory is allocated to one server, the computing system and the operation method of the same may handover the remote memory to another server through the optical switch when the load on the local memory of the other server is large. The computing system and the operation method of the same may effectively use limited memory resources to improve the utilization efficiency of the memory resources, and the resource allocation and the data migration may be made faster using the optical switch.

According to the embodiments of the present disclosure, the computing system for the remote memory allocation based on the optical switch and the operation method of the same according to the embodiments of the present disclosure may monitor the load of the local memory of the plurality of servers, respectively, and allocate the remote memory to the server with the large load of the local memory through the optical switch. In a state that the remote memory is allocated to one server, the computing system and the operation method of the same may handover the remote memory to another server through the optical switch when the load on the local memory of the other server is large. The computing system and the operation method of the same may effectively use limited memory resources to improve the utilization efficiency of the memory resources, and the resource allocation and the data migration may be made faster using the optical switch.

The above descriptions are detail embodiments for carrying out the present disclosure. The embodiments in which a design is changed simply or which are easily changed may be included in the present disclosure as well as an embodiment described above. In addition, technologies that are easily changed and implemented by using the above embodiments may be included in the present disclosure. Therefore, the scope of the present disclosure should not be limited to the above-described embodiments and should be defined by not only the claims to be described below, but also those equivalent to the claims of the present disclosure.

What is claimed is:

1. An operation method of a computing system for a remote memory allocation, the operation method comprising:
monitoring, by an each of a plurality of servers including a local memory and a CPU (Central Processing Unit), a load of the local memory;
requesting, by a first server of the plurality of servers, an allocation of a remote memory to an optical disaggregation manager when a load of a local memory of the first server is large;
checking whether the remote memory is allocated based on a request of the first server; and
allocating or hand overing the remote memory to the first server based on a result of the checking.

2. The operation method of claim 1, wherein the allocating or hand overing the remote memory to the first server includes:
allocating the remote memory to the first server, when the remote memory is not allocated to any of the plurality of servers; and
hand overing the remote memory to the first server, when the remote memory is allocated to one of the plurality of servers.

3. The operation method of claim 2, wherein the allocating the remote memory to the first server includes:
setting an optical switch such that a CPU of the first server and the remote memory are connected.

4. The operation method of claim 2, wherein the hand overing the remote memory to the first server includes:
requesting a handover of the remote memory to a second server of the plurality of servers, the remote memory being allocated to the second server;
monitoring a load of a local memory of the second server and a load of the remote memory based on the requesting of the handover; and
hand overing the remote memory from the second server to the first server based on a result of the monitoring.

5. The operation method of claim 4, wherein the monitoring the load of the local memory of the second server and the load of the remote memory includes:
notifying that the handover is available to the optical disaggregation manager, when the load of the local memory of the second server is small.

6. The operation method of claim 4, wherein the monitoring the load of the local memory of the second server and the load of the remote memory includes:
migrating data of the remote memory to the local memory of the second server, when the load of the local memory of the second server is small.

7. The operation method of claim 4, wherein the hand overing the remote memory from the second server to the first server includes:
disconnecting a CPU of the second server and the remote memory, and setting an optical switch such that a CPU of the first server and the remote memory are connected.

8. A computing system comprising:
an optical disaggregation manager;
an each of a plurality of servers including a local memory and a CPU (Central Processing Unit), and configured to monitor a load of the local memory; and
an optical switch configured to connect a remote memory with one of the plurality of servers,
wherein a first server of the plurality of servers is configured to request an allocation of the remote memory to the optical disaggregation manager, when a load of a local memory of the first server is large, and
wherein the optical disaggregation manager is configured to check whether the remote memory is allocated based on a request of the first server, and allocate or handover the remote memory to the first server, based on a result of the checking.

9. The computing system of claim 8, wherein the optical disaggregation manager is configured to:
allocate the remote memory to the first server, when the remote memory is not allocated to any of the plurality of servers, and
request a handover of the remote memory to the second server, when the remote memory is allocated to a second server of the plurality of servers.

10. The computing system of claim 9, wherein the optical disaggregation manager is configured to:
allocate the remote memory to the first server by setting the optical switch such that a CPU of the first server and the remote memory are connected, when allocating the remote memory to the first server.

11. The computing system of claim 9, wherein the second server is configured to:
monitor a load of a local memory of the second server and a load of the remote memory based on the requested handover, and notify that the handover is available to the optical disaggregation manager, when the load of the local memory of the second server is small.

12. The computing system of claim 11, wherein the second server is configured to:
migrate data of the remote memory to the local memory of the second server, when the load of the local memory of the second server is small.

13. The computing system of claim 11, wherein the optical disaggregation manager is configured to:
disconnect a CPU of the second server and the remote memory based on the notification of the second server that the handover is available, and set the optical switch such that a CPU of the first server and the remote memory are connected.

14. The computing system of claim 8, wherein the optical switch includes:
a plurality of host optical adapters, configured to convert signals respectively transmitted by the plurality of servers into optical signals and transmit the optical signals to the remote memory; and
a device optical adapter configured to convert a signal transmitted by the remote memory into an optical signal and transmit the optical signal to the plurality of servers.
